(19) United States
(12) Patent Application Publication
(10) Pub. No.: US 2025/0066214 A1
(43) Pub. Date: Feb. 27, 2025

(54) SINGLE-STEP LOW-TEMPERATURE CALCIUM CARBONATE PRODUCTION THROUGH CARBON DIOXIDE SEQUESTRATION OF MINERAL MATERIALS TO MAKE CONCRETE

(71) Applicant: CarbonBuilt, El Segundo, CA (US)

(72) Inventor: Iman MEHDIPOUR, Los Angeles, CA (US)

(21) Appl. No.: 18/821,772

(22) Filed: Aug. 30, 2024

Related U.S. Application Data
(63) Continuation of application No. 18/171,164, filed on Feb. 17, 2023.
(60) Provisional application No. 63/268,191, filed on Feb. 17, 2022.

(51) Int. Cl. C01F 11/18

(52) U.S. Cl. CPC C01F 11/182; C01F 11/181; C01P 2002/70; C01P 2004/51

(57) ABSTRACT

The disclosure herein sets forth processes and compositions for producing carbonated materials comprising calcium carbonates through a mechanochemical process. The present disclosure concerns the production of calcium carbonate by sequestrating CO₂. Certain processes herein include providing alkaline-rich mineral materials that include carbonatable solid wastes such as lime kiln dust, cement kiln dust, and coal combustion residues, and simultaneously fractioning the alkaline-rich mineral materials, while contacting the alkaline-rich mineral materials with a CO₂-containing gas in carbonation reactor at low temperature and ambient pressure. In some embodiments, the alkaline-rich mineral materials are partially carbonated before being used in the processes disclosed herein. After contacting the alkaline-rich mineral materials with a CO₂-containing gas in carbonation reactor at low temperature and ambient pressure, solid calcium carbonate is produced. In aqueous reactors, the solid calcium carbonate is filtered from a solution in which it precipitated, and the remaining solution includes hydroxide as well as alkaline metal ions. The solution filtered from the solid calcium carbonate can be sequentially contacted with a CO₂-containing gas stream to precipitate additional calcium carbonate. The carbonated materials formed from these processes can be used in the form of a slurry, as a moist powder, as a dried powder, as a reactive filler or as a supplementary cementitious material in a mixture that is used to make concrete.

### CROSS-REFERENCE TO RELATED APPLICATIONS

This applications claims priority to, and the benefit of, U.S. Provisional Patent Application No. 63/268,191, filed Feb. 17, 2022, and entitled SINGLE-STEP LOW-TEMPERATURE CALCIUM CARBONATE PRODUCTION THROUGH CARBONDIOXIDE SEQUESTRATION OF MINERAL MATERIALS, the entire contents of which are herein incorporated by reference in its entirety for all purposes.

### FIELD

The present disclosure concerns the production of calcium carbonate by sequestrating CO₂ via a mechanochemical process.

### BACKGROUND

Certain mineral-based materials (e.g., lime (CaO), portlandite (Ca(OH)₂), etc.) are effective in reacting with carbon dioxide (CO₂), sulfur trioxide (SO₃), sulfur dioxide (SO₂), nitrogen dioxide (NO₂), nitrogen trioxide (NO₃) and hydrogen chloride (HCl), and other flue gas components and are used to capture them from flue gas streams. For example, when portlandite-based sorbents are used for flue gas treatment (FGT), Ca(OH)₂ reacts with the flue gas components (e.g., CO₂, CO, SOₓ, NOₓ, HCl) to form, e.g., calcium carbonate (CaCO₃), calcium sulfite (CaSO₃), calcium sulfate (CaSO₄), and/or calcium chloride (CaCl₂), among other compounds. After such sorbents react with flue gas, they are considered a type of industrial mineral residue. Industrial mineral residues include, but are not limited to, cement kiln dust, lime kiln dust, off-spec fly ashes, and off-spec limes.

The high free-lime content present in some alkaline-rich (e.g., Ca- and Mg-rich) industrial mineral residues (e.g., lime, lime kiln dust, and cement kiln dust) restricts their incorporation as a concrete material due to the potential volumetric increase when such industrial mineral residues are hydrated. When these industrial residues increase in volume inside the concrete, they may expand and crack the concrete. This expansion and cracking adversely affect the mechanical performance and durability of the concrete.

Another problem with using alkaline-rich industrial mineral residues as a concrete material relates to their surface chemistry characteristics. Certain mineral residues used in FGTs, such as but not limited to lime or portlandite, may be made of a mixture of unreacted mineral sorbent (e.g., calcium oxide, calcium hydroxide, etc.) and spent sorbent (e.g., comprising calcium sulfates, calcium sulfites, calcium chlorides, calcium nitrate, calcium nitrite, and calcium carbonate compounds, etc.), depending on the FGT process type, FGT raw materials, the FGT process characteristics, and the points of collection of the mineral residues. Also, calcium carbonate and/or calcium sulfate form on portlandite particle surfaces in FGT processes. This calcium carbonate and/or calcium sulfate passivates the particle surfaces before the calcium hydroxide in the core of the particle can fully react with flue gas components. Calcium carbonate and/or calcium sulfate passivates the surface of portlandite and reduces the chemical accessibility of unreacted calcium hydroxide cores within portlandite residues to reactions with CO₂ gas. For example, the passivating surface layer(s) prevents CO₂ from diffusing through any pores in the portlandite and imposes a limit on diffusion-controlled carbonation reactions. Consequently, greater activation energy is required to force CO₂ gas diffusion through the passivation surface layer formed on partially-used portlandite FGT residues. This, in turn, makes the process more energy-intensive and limits the rate and extent of carbonation reaction. Such effects significantly reduce the performance efficiency of portlandite residues and thus limit the use (or reuse) potential of portlandite residues. Similar limitations attend the use of other mineral sorbents (e.g., lime (CaO)).

Another problem with using alkaline-rich industrial mineral residues as a concrete material relates to the agglomerated nature of the mineral residues. The agglomerates further hinder the accessibility of contacting CO₂-containing flue gases to the unreacted core of alkaline-rich residues and thereby limit CO₂ sequestration potential.

What is needed are new ways to develop energy-efficient methods to upcycle and improve the performance efficiency of alkaline-rich minerals and industrial residues by producing carbonated materials.

### SUMMARY

In one embodiment, set forth herein is a process for making calcium carbonate by sequestrating CO₂. The process includes a step of providing alkaline-rich mineral materials that include carbonatable solid wastes such as lime kiln dust, cement kiln dust, and coal combustion residues, any of which might be partially (or fully around particle surfaces) carbonated prior to this step. The process also includes simultaneously fractioning the alkaline-rich mineral materials, while contacting the alkaline-rich mineral materials with a CO₂-containing gas in a carbonation reactor at low temperature and ambient pressure. The process produces carbonated material solids. In those embodiments that use an aqueous reactor, the carbonated material solids are filtered from a solution that includes hydroxide ions (e.g., OH⁻) and alkaline ions (e.g., Ca²⁺ or Mg²⁺). In some embodiments, the pH of the solution is greater than, or equal to, 10, after the filtration. The solution is, in some embodiments, sequentially contacted with a CO₂-containing gas stream to precipitate additional calcium carbonate. The carbonated materials formed from this process can be used in the form of a slurry, in the form of a moist powder, or in the form of a dried powder, as reactive filler, or supplementary cementitious materials, to make concrete. The precipitated calcium carbonate materials, made from the processes disclosed herein, have a smaller particle size, after fractionating and carbonating, than the initial alkaline-rich mineral particles. The particle size reduction ranges from about 10% to about 99.999%. In certain embodiments, the particle size reduction ranges from about 10% to about 95%. In certain embodiments, the extent of CO₂ conversion of carbonatable minerals is controlled to be in the range of about 25% to about 100% (carbonation conversion) to supplement the chemical reaction among carbonated minerals, uncarbonated alkaline-rich minerals, and other constituents in a binder system comprising cement and fly ash in concrete mixtures.

In a second embodiment, set forth herein is a mechanochemical process for making calcium carbonate, wherein the process includes providing alkaline-rich mineral materials that are at least partially carbonated; simultaneously fractioning the alkaline-rich mineral materials, while contacting the alkaline-rich mineral materials with a CO₂-containing gas; wherein the contacting occurs at ambient pressure and temperatures ranging from 20° C. to 80° C.; thereby making calcium carbonate. In some embodiments, ambient pressure is 1 atmosphere (atm). In some embodiments, ambient pressure is the pressure inside the carbonation reactor.

In a third embodiment, set forth herein is an apparatus configured to implement a process disclosed herein.

### BRIEF DESCRIPTIONS OF THE DRAWINGS

FIG. 1 shows a process flow diagram for producing calcium carbonate materials by a mechanochemical process and with alkaline-rich mineral materials.

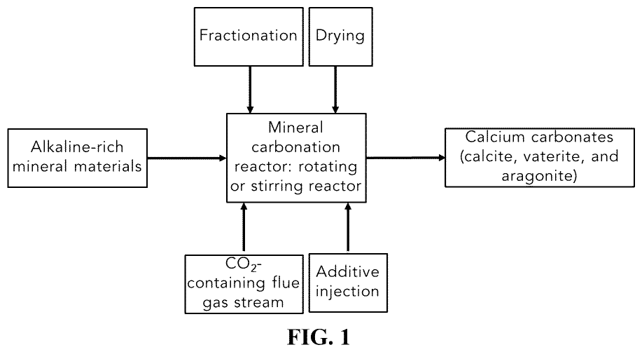

FIG. 2 shows the reactivity of lime kiln dust samples that are suspended in water as a function of time using the water extinction test following the European standard procedure (NF EN 549-2, 2002).

FIG. 3 shows the reactivity of lime kiln dust samples that are suspended in water as a function of time using the water extinction test following the European standard procedure (NF EN 549-2, 2002).

FIG. 4 shows the conversion of CaO to Ca(OH)₂ of LKD samples in the form of particulates after exposure to an air stream at varying relative humidity contents at T=50° C.

FIG. 5 shows the CO₂ uptake of LKD samples in the form of particulates after exposure to a CO₂-containing gas stream at 12 vol. % CO₂ and varying relative humidity contents at T=50° C. This example shows that a CO₂-containing gas stream in combination with water vapor when contacted with LKD particulates, can introduce simultaneous hydration and carbonation of LKD samples.

FIG. 6 shows a plot of CaCO₃ weight percent as a function of Phase sample. For each sample—E1 or E10—the numbers inside the parenthesis refer to, in series, the Reaction Temperature, the water-to-solid ratio, the CO₂ concentration, the flow rate, and the agitation ratio. For example, for E1 (25, 3, 100, 2, 200), the Reaction Temperature was 25° C., the water-to-solid ratio was 3, the CO₂ concentration was 100 volume percent, the flow rate was 2 slpm (standard liter per minute), and the agitation ratio was 200).

FIG. 7 shows a plot of weight percent (for Ca(OH)₂ and CaCO₃) as a function of Phase sample. For each sample—E6 or E8—the numbers inside the parenthesis refer to, in series, the Reaction Temperature, the water-to-solid ratio, the CO₂ concentration, the flow rate, and the agitation ratio. For example, for E6 (32.5, 2.25, 7, 1.25, 450), the Reaction Temperature was 32.5° C., the water-to-solid ratio was 2.25, the CO₂ concentration was 7 volume percent, the flow rate was 1.25 slpm, and the agitation ratio was 450).

FIG. 8 shows a plot of Temperature Rise (° C.) as a function of Time (min) for three samples. For each sample—E21, E22, and E25—the numbers inside the parenthesis refer to, in series, the Reaction Temperature, the water-to-solid ratio, the CO₂ concentration, the flow rate, and the agitation ratio. For example, for E21 (40, 2.25, 53.5, 1.25, 450), the Reaction Temperature was 40° C., the water-to-solid ratio was 2.25, the CO₂ concentration was 53.5 volume percent, the flow rate was 1.25 slpm, and the agitation ratio was 450).

FIG. 9 shows a plot of CaCO₃ formed (weight percent) as a function of Reaction temperature (° C.).

FIG. 10 shows an overlap of three x-ray diffraction plots for lime kiln dust, as-received, hydrated lime kiln dust, and carbonated lime kiln dust. The carbonated lime kiln dust plot is shown on top. The hydrated lime kiln dust plot is shown in the middle. The as-received lime kiln dust is shown on the bottom.

FIG. 11 shows a plot of cumulative Passing (%) as a function of Particle Size (μm) according to an embodiment.

FIG. 12 shows a plot of compressive strength (MPa) as a function of Age (day) according to an embodiment. OPC stands for ordinary portland cement. OPC-Uncarb LKD stands for ordinary portland cement with uncarbonated lime kiln dust. OPC-CARB-FRAC LKD stands for ordinary portland cement with carbonated and fractionated lime kiln dust.

FIG. 13 shows a plot of cumulative heat released (J/g cement) as a function of time (hr) according to an embodiment. OPC stands for ordinary portland cement. OPC-20%-CARB-FRAC stands for ordinary portland cement with 20% carbonated and fractionated lime kiln dust. OPC-20%-CARB stands for ordinary portland cement with 20% carbonated lime kiln dust. OPC-20%-CARB-20%-FRAC stands for ordinary portland cement with 20% carbonated lime kiln dust and 20% fractionated lime kiln dust.

### DETAILED DESCRIPTION

The disclosure herein provides processes and compositions for producing carbonated materials comprising calcium carbonates through a mechanochemical process. This process includes contacting alkaline-rich mineral materials including industrial residues with a CO₂-containing gas stream. The mechanochemical process includes combined fractionation and mineral carbonation reaction by contacting alkaline-rich mineral materials with CO₂-containing flue gas streams from industrial sources to sequester CO₂ and form calcium carbonate materials. The CO₂ sequestration method may be a dry (direct gas-solid) process, a semi-dry (gas-solid-water vapor) process, or an aqueous (gas-solid-liquid water) process. In these processes, alkaline-rich minerals are introduced in a rotating reactor or aqueous stirring reactor when contacted with a CO₂-containing flue gas stream to form carbonated materials. The process precipitates calcium carbonate particles such as, but not limited to, calcite, vaterite, aragonite, polymorphs thereof, or combinations thereof. The precipitated calcium carbonate particles have, in some examples, particle sizes in the range of nano to sub-microns (e.g., 1 nm to 1,000 nm for CaCO₃). The polymorphism, morphology, and reactivity of calcium carbonate particles are controlled by controlling reaction processing conditions such as temperature, relative humidity, flow rate, and the CO₂ concentration of the CO₂-containing flue gas stream that is in contact with the alkaline-rich mineral materials. The polymorphism, morphology, and reactivity of calcium carbonate particles may also be controlled, in some examples, by using additives such as ammonium salts. The calcium carbonate materials produced by the processes, herein, are utilized, in some examples, in concrete as a filler, aggregate, or reactant in the form of slurry or dried powder for both cast-in-place (e.g., ready mix concrete) and precast concrete applications.

The process includes the step of providing alkaline-rich mineral materials that include carbonatable solid wastes such as lime kiln dust, cement kiln dust, and coal combustion residues. These alkaline-rich mineral materials might be partially carbonated prior to being provided in the aforementioned process. The process includes simultaneously fractioning the alkaline-rich mineral materials while contacting the alkaline-rich mineral materials with a CO₂-containing gas in a carbonation reactor at low temperature and ambient pressure.

In some embodiments, the process produces calcium carbonate solids. In certain embodiments, the process occurs in a solution and the calcium carbonate solids are filtered. The filtration produces a solution that has hydroxide and alkaline ions in solution. In some embodiments, this solution is sequentially contacted with a CO₂-containing gas stream to precipitate additional calcium carbonate. In some embodiments, this solution has a pH greater than, or equal to, 10.

After the process herein, in some embodiments, the calcium carbonate (also referred to herein at carbonated materials) can be used in the form of a slurry to make concrete.

After the process herein, in some embodiments, the calcium carbonate (also referred to herein at carbonated materials) can be used as moist or as dry powder to make concrete.

After the process herein, in some embodiments, the calcium carbonate (also referred to herein at carbonated materials) can be used as a reactive filler to make concrete.

After the process herein, in some embodiments, the calcium carbonate (also referred to herein at carbonated materials) can be used as supplementary cementitious materials to make concrete.

The precipitated calcium carbonates from this process have a smaller particle size ranging from about 10% to about 100% than initial alkaline-rich mineral particles. In some embodiments, the extent of CO₂ conversion of carbonatable minerals in this process is controlled in the range of about 25% to about 100% (carbonation conversion) to supplement the chemical reaction among carbonated minerals, uncarbonated alkaline-rich minerals, and other constituents in a binder system comprising cement and fly ash in concrete mixtures.

### Definitions

As used herein, the singular terms “a,” “an,” and “the” include plural referents unless the context clearly dictates otherwise. Thus, for example, reference to an object can include multiple objects unless the context clearly dictates otherwise.

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used herein, the term “size” refers to a characteristic dimension of an object. Thus, for example, a size of an object that is circular can refer to a diameter of the object. In the case of an object that is non-circular, a size of the non-circular object can refer to a diameter of a corresponding circular object, where the corresponding circular object exhibits or has a particular set of derivable or measurable characteristics that are substantially the same as those of the non-circular object. Alternatively, or in conjunction, a size of a non-circular object can refer to an average of various orthogonal dimensions of the object. Thus, for example, a size of an object that is an ellipse can refer to an average of a major axis and a minor axis of the object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

As used herein, “carbonated materials” refers to materials made by contacting CO₂ to an alkaline-rich mineral material. Carbonate materials include, but are not limited to, —calcite, vaterite, aragonite, or combinations thereof. Carbonated materials may include oxides, hydroxides, carbonates, silicates, sulfites, sulfates, chlorides, nitrates, or nitrites of calcium and/or magnesium and/or other uni-/multi-valent elements, or any combination thereof.

As used herein, “alkaline-rich mineral materials” refers to virgin materials which include Ca and/or Mg and which are used in industrial processes or industrial residues. Alkaline-rich mineral materials include, but are not limited to, Ca(OH)₂, lime kiln dust, lime, hydrated lime, cement kiln dust, calcium-rich coal combustion residues, slag, off-spec fly ashes, biomass ashes, fluidized bed combustion ashes, circulating fluidized bed ashes, off-spec limes, mineral sorbent/scrubbing residues comprising anhydrous CaO and/or Ca(OH)₂, and combinations thereof. The alkaline-rich mineral materials may further comprise at least one of oxides, hydroxides, carbonates, silicates, sulfites, sulfates, chlorides, nitrates, or nitrites of calcium and/or magnesium, or any combination thereof.

Herein, a “residue” is an alkaline-rich mineral material which has been used in a flue gas treatment, for example, as a sorbent or scrubber or byproduct that are generated during industrial processes such as cement and lime manufacturing. A residue may include hydrated lime, lime kiln dust, cement kiln dust, fly ash, limestone, or combinations thereof. A residue may be referred to in the art as a mineral sorbent.

As used herein, the “reaction medium” is the environment in which the alkaline-rich mineral material is exposed to CO₂ and water during fractionation.

As used herein, the “reactive filler or supplementary cementitious materials” are materials that offer hydraulic or pozzolanic reactivity or a combination thereof that can be used as a partial replacement for cement.

As used herein, the “mineral carbonation reactor” is a reactor used to produce calcium carbonate by exposing, in a confined space, alkaline-rich mineral materials to a CO₂-containing gas stream.

As used herein, the “mechanochemical process” is a process that includes simultaneous (1) fractionation of alkaline-rich mineral materials and (2) mineral carbonation reaction via CO₂ exposure. In some embodiments, including any of the foregoing, the fractionation includes using a ball miller. In some embodiments, including any of the foregoing, the fractionation includes using milling media. In some embodiments, including any of the foregoing, the fractionation includes using steel ball milling media.

As used herein, the term “fractionation” is a process that cracks, fractures, breaks, pulverizes, and/or exposes unreacted active sites (e.g., core) of alkaline-rich minerals via milling, grinding, or pulverizing process. The process removes passivating layers, such as but not limited to calcium carbonate layers, on alkaline-rich mineral materials. Fractionation reduces a particle's particle size.

As used herein, the term “active carbonation,” refers to a process which results in a carbonation reaction rate that is above a natural value. For example, a carbonation rate at or above 0.005 per hour is a non-limiting example of active carbonation.

As used herein, the term “flow-through chamber,” refers to a chamber through which gas may be flowed continuously and at ambient pressure.

As used herein, the term “ambient pressure,” refers to atmospheric pressure on planet Earth. In an embodiment, ambient pressure is 1 atm.

As used herein, the term “gas conditioning apparatus,” refers to a system which is configured to receive a CO₂-containing flue gas stream and adjust the temperature, relative humidity, flow rate, CO₂ concentration, or a combination thereof, of the CO₂-containing flue gas stream before flowing the CO₂-containing flue gas stream out of the gas conditioning apparatus.

As used herein, the term “CO₂-containing flue gas stream,” refers to a gas stream effluent from a source other than the atmosphere and which includes carbon dioxide (CO₂).

As used herein, the term “a carbonated concrete composite,” refers to a carbonated concrete object (e.g., a building material) made from early-age (e.g., fresh) concrete that is then contacted with a CO₂-containing curing gas having a suitable CO₂ concentration.

As used herein, the term “concrete containing carbonated materials,” refers to a concrete object that is composed of carbonated materials in the form of slurry, aggregate, or dry powder, or any combination thereof.

As used herein, the term “material performance of a carbonated concrete composite” is defined as porosity, compressibility, and/or other mechanical or strength measurement (e.g., Young's modulus, yield strength, ultimate strength, fracture point, etc.).

As used herein, the term “negatively affecting the material performance,” refers to a material performance which is reduced in magnitude by a factor of 10 or more.

As used herein, the term “uniform material performance of a carbonated concrete component,” refers to substantially uniform material properties throughout the concrete component. That is, there are no significant gradients or variations in material performance from one area of the concrete composite to another area of the concrete composite.

As used herein, the extent of carbonation conversion and carbonation rate refers to the weight of calcium carbonate formed from the starting material, e.g., OPC or LKD.

As used herein, the phrase “mainly calcium carbonates and alumina-silica gel,” refers to a product mixture that is more than 50% by weight calcium carbonate. In some embodiments, the mixture is more than 90% by weight calcium carbonate. In some embodiments, including any of the foregoing, when two starting materials are used, such as LKD and fly ash, in which one starting material includes Al phases, Si phases, or both, then both calcium carbonate and alumina-silica carbonates may form during carbonation curing. In some other embodiments, when one starting material, such as portlandite, is used and which only includes Ca(OH)₂, then calcium carbonate may form but alumina-silica carbonates will not form during carbonation curing.

As used herein, the phrase “alkaline-rich mineral materials that are at least partially carbonated,” refers to alkaline-rich mineral materials that have some amount of calcium carbonate on their surface. A partially carbonated alkaline-rich mineral materials includes an alkaline-rich mineral material that has a discontinuous coating of calcium carbonate on its surface. A fully carbonated alkaline-rich mineral materials includes an alkaline-rich mineral material that has a continuous coating of calcium carbonate on its surface. Both partially carbonated alkaline-rich mineral materials and fully carbonated alkaline-rich mineral materials include an unreacted core. The partial or full carbonation of the alkaline-rich mineral materials refers to the extent that a carbonate coating is present on the alkaline-rich mineral materials.

### Embodiments

The present disclosure relates to a process for producing carbonated materials comprising calcium carbonates, wherein the process comprises subjecting alkaline-rich mineral materials to a mechanochemical process. The mechanochemical process includes simultaneous fractionation (i.e., grinding) and carbonation, in which the alkaline-rich mineral materials are contacted with a CO₂-containing flue gas stream in a carbonation process. The carbonated materials comprise at least one of calcite, vaterite, or aragonite, or any combination thereof. In some embodiments, including any of the foregoing, the CO₂-containing flue gas stream is substituted with a CO₂-containing gas stream which is derived from atmospheric air. In some embodiments, including any of the foregoing, direct air capture can be used to generate atmospherically derived CO₂.

In some embodiments, including any of the foregoing, the process occurs in a solvent-free and dry reaction medium. The solvent-free and dry reaction medium would only have a CO₂-containing flue gas stream contacting the alkaline-rich mineral materials during fractionation of the alkaline-rich mineral materials.

In some other examples, the process occurs in a semi-dry reaction medium. The semi-dry reaction medium would include the use of water vapor in combination with a CO₂-containing flue gas stream, both of which would contact the alkaline-rich mineral materials during fractionation of the alkaline-rich mineral materials. The solvent-free and dry reaction would, in some examples, be performed in a flow-through reactor. The semi-dry reaction would, in some examples, be performed in a flow-through reactor. In the semi-dry process, in one embodiment, water is introduced using a humidifier which adjusts the relative humidity of the CO₂-containing gas stream. In the semi-dry process, in one embodiment, water is introduced using a dry CO₂-containing gas stream and spraying water into the carbonation reactor. In some embodiments, including any of the foregoing, additives are included in the water which is sprayed into the reactor.

In yet other examples, the process occurs in a rotating or stirring carbonation reactor. In these examples, the process occurs in an aqueous/slurry. In the aqueous/slurry process, the CO₂-containing flue gas stream flows through a slurry or aqueous solution of solid alkaline-rich mineral material which is being stirred or rotated and fractionated or ground up.

Without being bound to theory, the fractioning and/or grinding of the alkaline-rich mineral material may help to access the Ca-rich (e.g., calcium hydroxide) material in the core of a particle of industrial alkaline-rich mineral residues. Such residues may have passivating surface layers of calcium carbonate, calcium sulfate, calcium nitrate, or other calcium-including species. By grinding up these alkaline-rich mineral residues, the passivating surface layers can be destroyed, and the inner core of the particles accessed chemically. The core of industrial alkaline-rich mineral residues includes Ca(OH)₂ which is activated by being exposed by the process herein. The fractioning also increases the surface area and decreases the particle size of the alkaline-rich mineral residues. This also helps to increase the accessibility of the reactive portions of the alkaline-rich mineral residues by increasing the amount of gas-solid interfaces. By flowing CO₂-containing flue gas stream simultaneously with fractioning, otherwise unreactive alkaline-rich mineral residues can be activated for carbonation reactions. By flowing CO₂-containing flue gas stream simultaneously with fractioning, otherwise less reactive alkaline-rich mineral residues can be activated to be more active for carbonation reactions.

In some embodiments, including any of the foregoing, including any of the foregoing, the mechanochemical process comprises a drying step. For example, in some embodiments, including any of the foregoing, the alkaline-rich mineral materials may be subjected to drying before, during, or after the mechanochemical process to produce carbonated materials comprising calcium carbonates. In some embodiments, including any of the foregoing, the drying temperature ranges from 20° C. to about 100° C.

In some embodiments, including any of the foregoing, the CO₂-containing gas stream is effluent from an industrial CO₂-containing gas stream, dilute flue gas stream, a concentrated CO₂ gas stream, a commercially available CO₂ source, liquefied CO₂, atmospherically-derived CO₂ (direct air capture), or biomass-derived CO₂. In some embodiments, including any of the foregoing, the CO₂-containing flue gas stream is substituted with a CO₂-containing gas stream which is derived from atmospheric air. In some embodiments, including any of the foregoing, direct air capture can be used to generate atmospherically derived CO₂.

In some embodiments, including any of the foregoing, the CO₂-containing gas stream is effluent from an industrial CO₂-containing gas stream.

In some embodiments, including any of the foregoing, the CO₂-containing gas stream is effluent from a dilute flue gas stream.

In some embodiments, including any of the foregoing, the CO₂-containing gas stream is effluent from a concentrated CO₂ gas stream.

In some embodiments, including any of the foregoing, the CO₂-containing gas stream is effluent from a commercially available CO₂ source.

In some embodiments, including any of the foregoing, the CO₂-containing gas stream is effluent from liquefied CO₂.

In some embodiments, including any of the foregoing, the CO₂-containing gas stream is effluent from atmospherically-derived CO₂ (direct air capture).

In some embodiments, including any of the foregoing, the CO₂-containing gas stream is effluent from biomass-derived CO₂.

In some embodiments, including any of the foregoing, the alkaline-rich mineral residue is collected by contacting a mineral sorbent with a carbon dioxide-containing gas stream (e.g., a flue gas) using scrubbing or sorbent injection (dry or semi-wet) methods. In some embodiments, the mineral sorbent residue is obtained by contacting a mineral sorbent with an atmospheric carbon dioxide source. In some embodiments, the alkaline-rich mineral residue is obtained during industrial processes such as cement and lime manufacturing processes which generate cement kiln dust and lime kiln dust.

In some embodiments, including any of the foregoing, the alkaline-rich mineral materials have an average particle size of less than 5 mm. In some embodiments, the mineral materials have an average particle size of at least about 500 μm. In some embodiments, the mineral material has an average particle size of at least about 100 μm. In some embodiments, the mineral material has an average particle size of less than about 500 nm. In some embodiments, the mineral material has an average particle size of less than about 100 nm. In some embodiments, the mineral material has an average particle size of less than about 10 nm. In some embodiments, the mineral material has an average particle size of less than about 1 nm.

In some embodiments, including any of the foregoing, the reaction medium is a solvent-free and dry reaction medium. In some embodiments, the reaction medium is semi-dry. In yet other embodiments, the reaction medium is an aqueous/slurry medium.

In some embodiments, including any of the foregoing, the liquid-to-solid weight ratio (w/w) of the reaction medium in the semi-dry process ranges from 0 to about 0.5. In some embodiments, including any of the foregoing, this ratio is controlled by controlling the relative humidity and moisture content of the CO₂-containing gas in the reactor or spraying water in the reactor. In some other examples, this ratio is controlled by controlling the relative humidity and moisture content of the CO₂-containing gas in the reactor or spraying water in the reactor. Without being bound to theory, it may be that the formation of liquid water films around surfaces of mineral materials enhances dissolution-precipitation reactions. Herein, the solids are alkaline-rich mineral materials or residues thereof.

Herein the phrases “liquid-to-solid weight ratio” and the “water-to-solid ratio” are used interchangeably.

In some embodiments, including any of the foregoing, the liquid-to-solid weight ratio of the reaction medium in the aqueous mineral carbonation process ranges from 0.5 to about 10.

In some embodiments, including any of the foregoing, the alkaline-rich mineral materials are simultaneously subjected to fractionation and calcium carbonate production (i.e., carbonation reaction) in a reactor which is configured to enhance intermixing and the gas-solid mass transfer occurring during calcium carbonate production. In some embodiments, the reactor is a carbonation chamber.

In some embodiments, including any of the foregoing, the mineral carbonation reactor comprises a rotating flow-through reactor or fluidized bed reactors for dry and semi-dry reaction mediums.

In some embodiments, including any of the foregoing, the mineral carbonation reactor comprises a stirring reactor for aqueous/slurry reaction mediums.

In some embodiments, including any of the foregoing, subjecting the mineral materials to fractionation/grinding comprises particle size reduction of particulates using mechanical-, acoustic-, thermal-, or electrical energy.

In some embodiments, including any of the foregoing, fractionation/grinding of mineral materials in a reactor comprises dry grinding, semi-wet grinding, or wet grinding. In some embodiments, including any of the foregoing, a milling media is also used.

In some embodiments, including any of the foregoing, fractionation/grinding of mineral materials in a reactor comprises dry grinding.

In some embodiments, including any of the foregoing, fractionation/grinding of mineral materials in a reactor comprises semi-wet grinding.

In some embodiments, including any of the foregoing, fractionation/grinding of mineral materials in a reactor comprises wet grinding.

In some embodiments, including any of the foregoing, fractionation of alkaline-rich mineral materials increases the surface area of the alkaline-rich mineral material that is contacted with the CO₂-containing flue gas stream in the mineral carbonation reactor. This increase in surface area improves the carbonation reaction rate and increases the extent (or amount) of the calcium carbonate materials produced by this process.

In some embodiments, including any of the foregoing, the carbonated material has an average particle size of at least about 1,000 μm.

In some embodiments, including any of the foregoing, the carbonated material has an average particle size of at least about 1 nm to about 1,000 nm.

In some embodiments, including any of the foregoing, the carbonated material has an average particle size of at least about 500 μm. In some embodiments, including any of the foregoing, the carbonated material has an average particle size of at least about 100 μm. In some embodiments, including any of the foregoing, the carbonated material has an average particle size of less than about 500 nm. In some embodiments, including any of the foregoing, the carbonated material has an average particle size of less than about 100 nm. In some embodiments, including any of the foregoing, the carbonated material has an average particle size of less than about 10 nm. In some embodiments, including any of the foregoing, the carbonated material has an average particle size of less than about 1 nm.

In some embodiments, including any of the foregoing, the carbonated material has an average particle size that is 10% of the size of the alkaline-rich mineral material from which the carbonated material was made.

In some embodiments, including any of the foregoing, the carbonated material has an average particle size that is 20% of the size of the alkaline-rich mineral material from which the carbonated material was made.

In some embodiments, including any of the foregoing, the carbonated material has an average particle size that is 30% of the size of the alkaline-rich mineral material from which the carbonated material was made.

In some embodiments, including any of the foregoing, the carbonated material has an average particle size that is 40% of the size of the alkaline-rich mineral material from which the carbonated material was made.

In some embodiments, including any of the foregoing, the carbonated material has an average particle size that is 50% of the size of the alkaline-rich mineral material from which the carbonated material was made.

In some embodiments, including any of the foregoing, the carbonated material has an average particle size that is 60% of the size of the alkaline-rich mineral material from which the carbonated material was made.

In some embodiments, including any of the foregoing, the carbonated material has an average particle size that is 70% of the size of the alkaline-rich mineral material from which the carbonated material was made.

In some embodiments, including any of the foregoing, the carbonated material has an average particle size that is 80% of the size of the alkaline-rich mineral material from which the carbonated material was made.

In some embodiments, including any of the foregoing, the carbonated material has an average particle size that is 90% of the size of the alkaline-rich mineral material from which the carbonated material was made.

In some embodiments, including any of the foregoing, the carbonated material has an average particle size that is 95% of the size of the alkaline-rich mineral material from which the carbonated material was made.

In some embodiments, including any of the foregoing, the carbonated material has an average particle size that is 99% of the size of the alkaline-rich mineral material from which the carbonated material was made.

In some embodiments, including any of the foregoing, the carbonated material has an average particle size that is 99.999% of the size of the alkaline-rich mineral material from which the carbonated material was made.

In some embodiments, including any of the foregoing, the polymorphism and morphology of produced calcium carbonates are preferentially controlled by reaction residence time, temperature, relative humidity, gas flow rate, and CO₂ concentration of the contacting gas stream. In some embodiments, the process produces a mixture of vaterite, aragonite, and calcite in carbonated materials.

Calcite is the most thermodynamically stable polymorph of calcium carbonate that forms when alkaline-rich mineral materials are contacted with CO₂-containing flue gas streams. However, the polymorphism and reactivity of calcium carbonate can be preferentially controlled by the reaction processing conditions and/or additive inclusions to control the kinetic growth of calcite and form different polymorphs of vaterite, aragonite, calcite, or any combination thereof. The reaction conditions comprise reaction medium, reaction temperature, reaction time, calcium concentration, mixing speed and time, and pH of the reaction medium. Additives are very useful to control the polymorphism and morphology of calcium carbonate. While calcite particles can be produced without additives, additives are largely employed to synthesize vaterite and aragonite particles or combinations thereof. Additives comprise ammonium salts, sulfates, chloride, magnesium, alcohol, amine-based species, and polyethylene glycol (PEG). For instance, the addition of NH₄HCO₃ and CaCl₂ solutions can create an interaction onto the surface of the alkaline-rich particles that favors their formation during mineral carbonation. However, U.S. Pat. Nos. 5,792,440; 8,367,025; 9,902,652; and 8,721,785 as well as US Patent Application No. US 2021/0261429A1 are based on a two-step process comprising aqueous solution formation of alkaline materials, additives, and water and then contacting the aqueous solutions with carbon dioxide to precipitate carbonated materials comprising calcium carbonates.

In some embodiments, including any of the foregoing, the process includes controlling temperature, relative humidity, the concentration of CO₂, and the use of additives to favor the formation of vaterite or aragonite, or both, over the formation of calcite, which is the thermodynamically stable form of CaCO₃. For example, lower reaction temperatures (e.g., 50° C. or less) favor the formation of vaterite. Above 50° C., calcite is favored.

In some embodiments, including any of the foregoing, additives are introduced by bubbling a CO₂-containing gas through an additive-containing solution. In some embodiments, including any of the foregoing, additives are introduced by injecting solid additives into the carbonation reactor. In some embodiments, including any of the foregoing, additives are introduced by mixing the additive with water and introducing the water mixture or water solution which results from the mixing into the carbonation reactor.

Higher CO₂ concentrations (e.g., 50% or more) also favor the formation of aragonite and vaterite as well as the favor the formation of calcite.

Additives are needed in some examples to form vaterite or aragonite. Additives are not needed to form calcite.

In some embodiments, including any of the foregoing, the process forms vaterite as spherically-shaped particles.

In some embodiments, including any of the foregoing, the process forms calcite as cubic-shaped particles.

In some embodiments, including any of the foregoing, the process forms aragonite as needle-shaped particles.

In some embodiments, including any of the foregoing, alcohols are used to stabilize vaterite, aragonite, or a mixture thereof.

In some embodiments, including any of the foregoing, the process herein forms calcite.

In some embodiments, including any of the foregoing, the process herein forms calcite and vaterite.

In some embodiments, including any of the foregoing, the process herein forms calcite and aragonite.

In some embodiments, including any of the foregoing, the process herein forms calcite, vaterite, and aragonite.

In some embodiments, including any of the foregoing, the process herein forms aragonite and vaterite.

In some embodiments of the solvent-free and dry process, as well as the semi-dry process, the mineral carbonation in a rotating reactor, and the relative humidity of contacting gas stream ranges from about 10% to about 90%. In some embodiments, including any of the foregoing, the temperature of contacting CO₂-containing flue gas stream ranges from 20° C. to about 100° C. In some embodiments, including any of the foregoing, the CO₂ concentration of the CO₂-containing flue gas ranges from 5% to about 100% by volume. In some embodiments, including any of the foregoing, the reaction residence time ranges from 5 minutes to about 48 hours. Herein, the reaction residence time is the time that the alkaline-rich mineral materials are in contact with the CO₂-containing gas while undergoing fractionation and/or grinding.

In some embodiments, of the aqueous mineral carbonation process in a stirring reactor, the temperature of contacting gas stream ranges from 20° C. to about 100° C. In some embodiments, including any of the foregoing, the CO₂ concentration of contacting gas streams ranges from 5% to about 100% by volume. In some embodiments, including any of the foregoing, the reaction residence time ranges from 5 minutes to about 48 hours. In some embodiments, including any of the foregoing, the stirring speed ranges from 5 rpm (revolution per minute) to about 10000 rpm.

Herein, the reaction residence time is the time that the alkaline-rich mineral materials are in contact with the CO₂-containing gas while undergoing fractionation and/or grinding.

In some embodiments, including any of the foregoing, the flow rate of the CO₂-containing flue gas stream contacting the alkaline-rich mineral materials in the mineral carbonation reactor is at least 1 liter per minute (Standard liters per minute; SLPM).

In some embodiments, including any of the foregoing, the polymorphism of produced calcium carbonates is controlled by contacting the alkaline-rich mineral materials with additives during the fractionation and/or grinding process. The additives may include, but are not limited to chlorides (e.g., CaCl₂), sulfates (e.g., CaSO₄), and ammonium salts (e.g., NH₄NO₃; NH₄Cl). In some embodiments, including any of the foregoing, the additives are introduced using additive injection into the carbonation reactor where the alkaline-rich mineral materials are undergoing fractionation and/or grinding.

In some embodiments, including any of the foregoing, the process includes contacting the additives with the alkaline-rich mineral materials during the mechanochemical process in a mineral carbonation reactor. In some embodiments, including any of the foregoing, the additives are selected from at least one of sodium hydroxide, potassium hydroxide, lithium hydroxide, calcium hydroxide, magnesium hydroxide, ammonium hydroxide, ammonium carbonate, ammonium chloride, calcium sulfate, calcium chloride, calcium nitrate, sodium carbonate, sodium bicarbonate, ammonia, trimethylamine, trimethylamine, monoethanolamine, diethanolamine, triethanolamine, isopropanolamine, diisopropanolamine, triisopropanolamine, alkali metal silicates, alkaline earth metal silicates, and combinations thereof.

In some embodiments, including any of the foregoing, the CO₂-containing flue gas stream is bubbled in an aqueous solution of water and additives comprising ammonium salts to produce an ammonia-CO₂ gas mixture before contacting the ammonia-CO₂ gas mixture with the alkaline-rich mineral materials in a mineral carbonation reactor.

In some embodiments, including any of the foregoing, the produced calcium carbonate materials are subjected to drying.

In some embodiments, including any of the foregoing, the produced calcium carbonate materials are subjected to alcohol washing and drying to stabilize the morphology of produced calcium carbonate materials. Herein, the morphology refers to particle size, particle shape, aggregate shape, aggregate size, and combinations thereof.

In some embodiments, including any of the foregoing, the produced calcium carbonate materials are subjected to additional fractionation to control particle sizes in the range of nano to microns (e.g., 1 nm to 1000 μm)

In some embodiments, including any of the foregoing, the produced calcium carbonate materials are subjected to washing treatment comprising alcohol to remove residual additives comprising chloride, sulfate, and ammonium salts from the surfaces of calcium carbonate particles.

In some embodiments, including any of the foregoing, the process includes washing carbonated materials with alcohol and drying them. In some embodiments, including any of the foregoing, the process includes recovering residual additives comprising ammonium salts after washing carbonated materials with alcohol and drying.

In some embodiments, including any of the foregoing, the produced calcium carbonate materials are used in concrete in the form of dried powder, aggregate or slurry comprising a mixture of water, calcium carbonates, and additives for precast and/or cast-in-place concrete (e.g., ready mix concrete) applications.

In some embodiments, including any of the foregoing, the method for producing calcium carbonates comprises a rotating reactor, fluidized bed reactor, or stirring reactor, which is configured to control material feeding rate, gas temperature, gas relative humidity, gas flow rate, gas recirculation rate, pH of the reaction medium, additive injection rate, reaction resistance time, stirring speed, and fractionation extent.

In another aspect, which may be combined with any other aspect or embodiment, the present disclosure sets forth a process for forming a concrete component comprising: forming a cementitious slurry comprising aggregates and carbonated materials obtained from the mechanochemical process, set forth herein, in the form of dry powder or slurry; shaping the cementitious slurry into a structural component; and exposing the structural component to carbon dioxide sourced from CO₂ emission sources (e.g., industrial CO₂-containing gas stream, dilute flue gas stream, a concentrated CO₂ gas stream), or from the atmosphere, thereby forming the concrete component.

In some embodiments, including any of the foregoing, the cementitious slurry further comprises a second mineral material that has not been subjected to a mechanochemical process to obtain the reactivated mineral material. Herein, the second mineral material may include, but is not limited to, cement, aggregate, fly ash, gypsum, lime kiln dust, cement kiln dust, and natural porcelains.

In some embodiments, including any of the foregoing, the shaping comprises casting, extruding, molding, pressing, or 3D-printing of the cementitious slurry comprising carbonated materials.

In some embodiments, including any of the foregoing, the cementitious slurry comprising carbonated materials is cast without shaping such as in ready-mix concrete applications.

In some embodiments, including any of the foregoing, the cementitious slurry comprising carbonated materials is cast without shaping such as ready-mix concrete applications, and without subsequent carbonation curing.

In some embodiments, including any of the foregoing, the produced calcium carbonate materials can reduce cement content in concrete mixtures by up to 50% while fulfilling the performance requirements. By controlling the morphology, the produced nano-sized (e.g., 1 nm to 1,000 μm) calcium carbonate materials can provide filler effect and chemical effect comprising additional nucleation sites for cement hydration and carboaluminate formation through a reaction between calcium carbonate and aluminate phases as well as stabilizing ettringite. The resulting increased solid volume through the combined filler and chemical effects densifies the concrete microstructure and improves porosity.

In some embodiments, including any of the foregoing, the carbonated mineral materials can be used as aggregate in concrete to enhance mechanical properties and improve porosity. The precipitation of calcium carbonates on surfaces of mineral materials can serve as additional nucleation sites to improve cement hydration as well as form carboaluminate phases and enhance the stability of ettringite. This can result in a denser interfacial transition zone between carbonated mineral particles and cement paste that enhances the mechanical properties of concrete.

In some embodiments, including any of the foregoing, the present disclosure sets forth a process for stabilizing compounds comprising sulfates, sulfites, and/or chlorides in the mineral materials, the method comprising: forming mineral carbonates on surfaces of mineral materials through the mechanochemical process.

In some embodiments, set forth herein is a mechanochemical process for making calcium carbonate, including: providing alkaline-rich mineral materials that are at least partially carbonated; simultaneously fractioning the alkaline-rich mineral materials, while contacting the alkaline-rich mineral materials with a CO₂-containing gas; wherein the contacting occurs at ambient pressure and temperatures ranging from 20° C. to 80° C.; thereby making calcium carbonate. In certain embodiments, the temperature is 20° C. to 40° C. In certain embodiments, the temperature is 32.5° C. In certain embodiments, the temperature is 20° C. to 32.5° C.

In some embodiments, including any of the foregoing, the process includes providing alkaline-rich mineral materials in a solution or slurry, and simultaneously fractioning the alkaline-rich mineral materials in the solution, while contacting the alkaline-rich mineral materials with a CO₂-containing gas; and wherein the process further includes filtering the calcium carbonate from the solution.

In some embodiments, including any of the foregoing, the solution includes hydroxide ions, alkaline metal ions, or a combination thereof.

In some embodiments, including any of the foregoing, the solution has a pH greater than, or equal to, 10 after filtering the calcium carbonate from the solution.

In some embodiments, including any of the foregoing, process includes contacting the solution after filtering the solution with the CO₂-containing gas to form additional calcium carbonate.

In some embodiments, including any of the foregoing, process includes using the calcium carbonate made by the process as a reactive filler or supplementary cementitious material to make concrete.

In some embodiments, set forth herein is concrete made using the calcium carbonate made by a process disclosed herein.

In some embodiments, including any of the foregoing, process includes using the calcium carbonate made by the process in a slurry, as a moist powder, or as a dry powder.

In some embodiments, including any of the foregoing, calcium carbonate made from the process has a smaller particle size than the particle size of the alkaline-rich mineral particles.

In some embodiments, including any of the foregoing, calcium carbonate made from the process has a smaller particle size than the particle size of the alkaline-rich mineral particles by a factor ranging from about 10% to about 95%. In certain embodiments, the factor is 10%. In certain embodiments, the factor is 20%. In certain embodiments, the factor is 30%. In certain embodiments, the factor is 40%. In certain embodiments, the factor is 50%. In certain embodiments, the factor is 60%. In certain embodiments, the factor is 70%. In certain embodiments, the factor is 80%. In certain embodiments, the factor is 90%. In certain embodiments, the factor is 95%.

In some embodiments, including any of the foregoing, process includes conditioning the CO₂-containing gas to achieve an extent of carbonation conversion and carbonation rate of alkaline-rich mineral minerals of about 25% to about 100%. In certain embodiments, the temperature is 20° C. In certain embodiments, the temperature is 32° C. In certain embodiments, the temperature is 32.5° C. In certain embodiments, the temperature is 40° C.

In some embodiments, including any of the foregoing, process includes controlling the carbonation reaction rate of the alkaline-rich minerals by adjusting flow rate, temperature, CO₂ concentration, and the time during which the CO₂-containing gas contacts the alkaline-rich minerals.

In some embodiments, including any of the foregoing, process includes adding an additive in addition to alkaline rich mineral during the fractioning and mineral carbonation reaction in the reaction medium.

In some embodiments, including any of the foregoing, the additive is added by mixing the additive with the alkaline-rich minerals at the beginning of the process.

In some embodiments, including any of the foregoing, the additive is added by injection addition.

In some embodiments, including any of the foregoing, the additive is added by spraying a solution of the additive and water onto the alkaline-rich mineral material during fractioning.

In some embodiments, including any of the foregoing, process includes bubbling the CO₂-containing gas through a solution including the additive.

In some embodiments, including any of the foregoing, the carbonation products are mainly calcium carbonates and alumina-silica gel, or a combination thereof.

In some embodiments, including any of the foregoing, the process occurs in a carbonation chamber.

In some embodiments, including any of the foregoing, the process occurs in a reaction medium, and wherein the reaction medium is selected from dry, semi-dry and aqueous reaction medium.

In some embodiments, including any of the foregoing, the reaction medium is semi-dry, and the liquid-to-solid weight ratio (w/w) ranges from 0 to about 10.

In some embodiments, including any of the foregoing, the reaction medium is aqueous, and the liquid-to-solid weight ratio (w/w) ranges from 0.5 to about 10.

In some embodiments, including any of the foregoing, the CO₂-containing gas is a flue gas effluent from an industrial CO₂-containing gas stream, dilute flue gas stream, a concentrated CO₂ gas stream, a commercially available CO₂ source, liquefied CO₂, atmospherically-derived CO₂ (direct air capture), or biomass-derived CO₂.

In some embodiments, including any of the foregoing, the atmospherically-derived CO₂ is direct air capture CO₂.

In some embodiments, including any of the foregoing, fractioning the alkaline-rich mineral materials increases the surface area of the alkaline-rich mineral materials.

In some embodiments, including any of the foregoing, prior to fractioning the alkaline-rich mineral materials, the alkaline-rich mineral materials are partially carbonated. This means that the alkaline-rich mineral materials have some coating of calcium carbonate on its surface but that the coating may a discontinuous coating.

In some embodiments, including any of the foregoing, prior to fractioning the alkaline-rich mineral materials, the alkaline-rich mineral materials are fully carbonated at their particle surfaces. This means that the alkaline-rich mineral materials have a continuous coating of calcium carbonate on its surface.

In some embodiments, including any of the foregoing, fractioning the alkaline-rich mineral materials decreases the average particle size of the alkaline-rich mineral materials.

In some embodiments, including any of the foregoing, the precipitated calcium carbonate includes vaterite, aragonite, calcite, and combinations thereof.

In some embodiments, including any of the foregoing, the process is a solvent-free and dry process.

In some embodiments, including any of the foregoing, the process is a semi-dry process.

In some embodiments, including any of the foregoing, the process occurs in a flow-through reactor.

In some embodiments, including any of the foregoing, the flow-through reactor is selected from a rotating flow-through reactor or a fluidized bed reactor.

In some embodiments, including any of the foregoing, the process occurs in an aqueous solution.

In some embodiments, including any of the foregoing, the process occurs in a slurry.

In some embodiments, including any of the foregoing, the process occurs in a stirring reactor.

In some embodiments, including any of the foregoing, the alkaline-rich mineral materials are selected from virgin minerals, mineral residues, and combinations thereof.

In some embodiments, including any of the foregoing, the alkaline-rich mineral materials are alkaline-rich mineral residues, and wherein the alkaline-rich mineral residues are generated from industrial processes such as cement kiln dust, lime kiln dust, coal combustion residues, fly ash, slag off-spec limes, carbide lime.

In some embodiments, including any of the foregoing, the alkaline-rich mineral material are alkaline-rich mineral residues, and wherein the alkaline-rich mineral residues are collected from flue gas treatments such as lime scrubbing materials, lime sorbents, and lime sludge.

In some embodiments, including any of the foregoing, the alkaline-rich mineral material comprises lime kiln dust.

In some embodiments, including any of the foregoing, the alkaline-rich mineral material comprises lime kiln dust and fly ash.

In some embodiments, including any of the foregoing, the alkaline-rich mineral material comprises lime and fly ash.

In some embodiments, including any of the foregoing, the alkaline-rich mineral material comprises fly ash.

In some embodiments, including any of the foregoing, the alkaline-rich mineral material consists of lime kiln dust.

In some embodiments, including any of the foregoing, the alkaline-rich mineral material consists of lime kiln dust and fly ash.

In some embodiments, including any of the foregoing, the alkaline-rich mineral material consists of lime and fly ash.

In some embodiments, including any of the foregoing, the alkaline-rich mineral material consists fly ash.

In some embodiments, including any of the foregoing, the alkaline-rich mineral material consists essentially of lime kiln dust.

In some embodiments, including any of the foregoing, the alkaline-rich mineral material consists essentially of lime kiln dust and fly ash.

In some embodiments, including any of the foregoing, the alkaline-rich mineral material consists essentially of lime and fly ash.

In some embodiments, including any of the foregoing, the alkaline-rich mineral material consists essentially of fly ash.

In some embodiments, including any of the foregoing, the alkaline-rich mineral materials have a passivating layer on their surface prior to fractioning the alkaline-rich mineral materials.

In some embodiments, including any of the foregoing, the alkaline-rich mineral material is a portlandite residue.

In some embodiments, including any of the foregoing, the portlandite is untreated.

In some embodiments, including any of the foregoing, the temperature of the CO₂-containing gas ranges from 20° C. to about 100° C.

In some embodiments, including any of the foregoing, the temperature of the CO₂-containing gas ranges from 20° C. to about 80° C.

In some embodiments, including any of the foregoing, the contacting occurs at ambient pressure and temperatures ranging from 20° C. to 60° C.

In some embodiments, including any of the foregoing, the contacting occurs at ambient pressure and temperatures ranging from 20° C. to 40° C.

In some embodiments, including any of the foregoing, the contacting occurs at ambient pressure and temperatures ranging from 20° C. to 35° C.

In some embodiments, including any of the foregoing, the contacting occurs at ambient pressure and temperatures ranging from 20° C. to 32.5° C.

In some embodiments, including any of the foregoing, the contacting occurs at ambient pressure and temperatures ranging from 32.5° C. to 40° C.

In some embodiments, including any of the foregoing, the contacting occurs at ambient pressure and temperatures ranging from 35° C. to 40° C.

In some embodiments, including any of the foregoing, the contacting occurs at ambient pressure and temperatures less than 40° C.

In some embodiments, including any of the foregoing, the contacting occurs at ambient pressure and temperatures greater than 20° C.

In some embodiments, including any of the foregoing, the contacting occurs at ambient pressure and 32.5° C.

In some embodiments, including any of the foregoing, the CO₂ concentration of the CO₂-containing gas ranges from 5% to about 100% by volume. In certain embodiments, the CO₂ concentration of the CO₂-containing gas is 5% by volume. In certain embodiments, the CO₂ concentration of the CO₂-containing gas is 6% by volume. In certain embodiments, the CO₂ concentration of the CO₂-containing gas is 7% by volume. In certain embodiments, the CO₂ concentration of the CO₂-containing gas is 8% by volume. In certain embodiments, the CO₂ concentration of the CO₂-containing gas is 9% by volume. In certain embodiments, the CO₂ concentration of the CO₂-containing gas is 10% by volume. In certain embodiments, the CO₂ concentration of the CO₂-containing gas is 11% by volume. In certain embodiments, the CO₂ concentration of the CO₂-containing gas is 12% by volume. In certain embodiments, the CO₂ concentration of the CO₂-containing gas is 13% by volume. In certain embodiments, the CO₂ concentration of the CO₂-containing gas is 14% by volume. In certain embodiments, the CO₂ concentration of the CO₂-containing gas is 15% by volume. In certain embodiments, the CO₂ concentration of the CO₂-containing gas is 16% by volume. In certain embodiments, the CO₂ concentration of the CO₂-containing gas is 17% by volume. In certain embodiments, the CO₂ concentration of the CO₂-containing gas is 18% by volume. In certain embodiments, the CO₂ concentration of the CO₂-containing gas is 19% by volume. In certain embodiments, the CO₂ concentration of the CO₂-containing gas is 20% by volume. In certain embodiments, the CO₂ concentration of the CO₂-containing gas is 21% by volume. In certain embodiments, the CO₂ concentration of the CO₂-containing gas is 22% by volume. In certain embodiments, the CO₂ concentration of the CO₂-containing gas is 23% by volume. In certain embodiments, the CO₂ concentration of the CO₂-containing gas is 24% by volume. In certain embodiments, the CO₂ concentration of the CO₂-containing gas is 25% by volume. In certain embodiments, the CO₂ concentration of the CO₂-containing gas is 26% by volume. In certain embodiments, the CO₂ concentration of the CO₂-containing gas is 27% by volume. In certain embodiments, the CO₂ concentration of the CO₂-containing gas is 28% by volume. In certain embodiments, the CO₂ concentration of the CO₂-containing gas is 29% by volume. In certain embodiments, the CO₂ concentration of the CO₂-containing gas is 30% by volume. In certain embodiments, the CO₂ concentration of the CO₂-containing gas is 31% by volume. In certain embodiments, the CO₂ concentration of the CO₂-containing gas is 32% by volume. In certain embodiments, the CO₂ concentration of the CO₂-containing gas is 33% by volume. In certain embodiments, the CO₂ concentration of the CO₂-containing gas is 34% by volume. In certain embodiments, the CO₂ concentration of the CO₂-containing gas is 35% by volume. In certain embodiments, the CO₂ concentration of the CO₂-containing gas is 36% by volume. In certain embodiments, the CO₂ concentration of the CO₂-containing gas is 37% by volume. In certain embodiments, the CO₂ concentration of the CO₂-containing gas is 38% by volume. In certain embodiments, the CO₂ concentration of the CO₂-containing gas is 39% by volume. In certain embodiments, the CO₂ concentration of the CO₂-containing gas is 40% by volume. In certain embodiments, the CO₂ concentration of the CO₂-containing gas is 41% by volume. In certain embodiments, the CO₂ concentration of the CO₂-containing gas is 42% by volume. In certain embodiments, the CO₂ concentration of the CO₂-containing gas is 43% by volume. In certain embodiments, the CO₂ concentration of the CO₂-containing gas is 44% by volume. In certain embodiments, the CO₂ concentration of the CO₂-containing gas is 45% by volume. In certain embodiments, the CO₂ concentration of the CO₂-containing gas is 46% by volume. In certain embodiments, the CO₂ concentration of the CO₂-containing gas is 47% by volume. In certain embodiments, the CO₂ concentration of the CO₂-containing gas is 48% by volume. In certain embodiments, the CO₂ concentration of the CO₂-containing gas is 49% by volume. In certain embodiments, the CO₂ concentration of the CO₂-containing gas is 50% by volume. In certain embodiments, the CO₂ concentration of the CO₂-containing gas is 51% by volume. In certain embodiments, the CO₂ concentration of the CO₂-containing gas is 52% by volume. In certain embodiments, the CO₂ concentration of the CO₂-containing gas is 53% by volume. In certain embodiments, the CO₂ concentration of the CO₂-containing gas is 54% by volume. In certain embodiments, the CO₂ concentration of the CO₂-containing gas is 55% by volume. In certain embodiments, the CO₂ concentration of the CO₂-containing gas is 56% by volume. In certain embodiments, the CO₂ concentration of the CO₂-containing gas is 57% by volume. In certain embodiments, the CO₂ concentration of the CO₂-containing gas is 58% by volume. In certain embodiments, the CO₂ concentration of the CO₂-containing gas is 59% by volume. In certain embodiments, the CO₂ concentration of the CO₂-containing gas is 60% by volume. In certain embodiments, the CO₂ concentration of the CO₂-containing gas is 61% by volume. In certain embodiments, the CO₂ concentration of the CO₂-containing gas is 62% by volume. In certain embodiments, the CO₂ concentration of the CO₂-containing gas is 63% by volume. In certain embodiments, the CO₂ concentration of the CO₂-containing gas is 64% by volume. In certain embodiments, the CO₂ concentration of the CO₂-containing gas is 65% by volume. In certain embodiments, the CO₂ concentration of the CO₂-containing gas is 66% by volume. In certain embodiments, the CO₂ concentration of the CO₂-containing gas is 67% by volume. In certain embodiments, the CO₂ concentration of the CO₂-containing gas is 68% by volume. In certain embodiments, the CO₂ concentration of the CO₂-containing gas is 69% by volume. In certain embodiments, the CO₂ concentration of the CO₂-containing gas is 70% by volume. In certain embodiments, the CO₂ concentration of the CO₂-containing gas is 71% by volume. In certain embodiments, the CO₂ concentration of the CO₂-containing gas is 72% by volume. In certain embodiments, the CO₂ concentration of the CO₂-containing gas is 73% by volume. In certain embodiments, the CO₂ concentration of the CO₂-containing gas is 74% by volume. In certain embodiments, the CO₂ concentration of the CO₂-containing gas is 75% by volume. In certain embodiments, the CO₂ concentration of the CO₂-containing gas is 76% by volume. In certain embodiments, the CO₂ concentration of the CO₂-containing gas is 77% by volume. In certain embodiments, the CO₂ concentration of the CO₂-containing gas is 78% by volume. In certain embodiments, the CO₂ concentration of the CO₂-containing gas is 79% by volume. In certain embodiments, the CO₂ concentration of the CO₂-containing gas is 80% by volume. In certain embodiments, the CO₂ concentration of the CO₂-containing gas is 81% by volume. In certain embodiments, the CO₂ concentration of the CO₂-containing gas is 82% by volume. In certain embodiments, the CO₂ concentration of the CO₂-containing gas is 83% by volume. In certain embodiments, the CO₂ concentration of the CO₂-containing gas is 84% by volume. In certain embodiments, the CO₂ concentration of the CO₂-containing gas is 85% by volume. In certain embodiments, the CO₂ concentration of the CO₂-containing gas is 86% by volume. In certain embodiments, the CO₂ concentration of the CO₂-containing gas is 87% by volume. In certain embodiments, the CO₂ concentration of the CO₂-containing gas is 88% by volume. In certain embodiments, the CO₂ concentration of the CO₂-containing gas is 89% by volume. In certain embodiments, the CO₂ concentration of the CO₂-containing gas is 90% by volume. In certain embodiments, the CO₂ concentration of the CO₂-containing gas is 91% by volume. In certain embodiments, the CO₂ concentration of the CO₂-containing gas is 92% by volume. In certain embodiments, the CO₂ concentration of the CO₂-containing gas is 93% by volume. In certain embodiments, the CO₂ concentration of the CO₂-containing gas is 94% by volume. In certain embodiments, the CO₂ concentration of the CO₂-containing gas is 95% by volume. In certain embodiments, the CO₂ concentration of the CO₂-containing gas is 96% by volume. In certain embodiments, the CO₂ concentration of the CO₂-containing gas is 97% by volume. In certain embodiments, the CO₂ concentration of the CO₂-containing gas is 98% by volume. In certain embodiments, the CO₂ concentration of the CO₂-containing gas is 99% by volume. In certain embodiments, the CO₂ concentration of the CO₂-containing gas is 100% by volume.

In some embodiments, including any of the foregoing, the time for contacting the alkaline-rich mineral materials with a CO₂-containing gas ranges from 5 minutes to about 48 hours.

In some embodiments, including any of the foregoing, the flow rate of the CO₂-containing gas stream in the carbonation chamber is at least 1 liter per minute.

In some embodiments, including any of the foregoing, the flow rate of the CO₂-containing gas stream in the reactor is at least 1 liter per minute.

In some embodiments, including any of the foregoing, process includes washing the vaterite, aragonite, calcite, or a combination thereof, with alcohol.

In some embodiments, including any of the foregoing, process includes drying the vaterite, aragonite, calcite, or a combination thereof.

In some embodiments, including any of the foregoing, the morphology of the vaterite, aragonite, calcite, or a combination thereof, is stabilized.

In some embodiments, including any of the foregoing, process includes using the vaterite, aragonite, calcite, or a combination thereof, in concrete in the form of dried powder, aggregate, or slurry.

In some embodiments, including any of the foregoing, the slurry includes a mixture of water, calcium carbonates, and additives for precast and/or cast-in-place concrete.

In some embodiments, including any of the foregoing, the additives for precast and/or cast-in-place concrete include ready mix concrete.

In some embodiments, including any of the foregoing, the additive is selected from the group consisting of CaCl₂, CaSO₄, NH₄NO₃, NH₄Cl, and combinations thereof.

In some embodiments, including any of the foregoing, the additive is CaCl₂.

In some embodiments, including any of the foregoing, the additive is CaSO₄.

In some embodiments, including any of the foregoing, the additive is NH₄NO₃.

In some embodiments, including any of the foregoing, the additive is NH₄Cl.

In some embodiments, including any of the foregoing, the additive is selected from the group consisting of sodium hydroxide, potassium hydroxide, lithium hydroxide, calcium hydroxide, magnesium hydroxide, ammonium hydroxide, ammonium carbonate, ammonium chloride, calcium sulfate, calcium chloride, calcium nitrate, sodium carbonate, sodium bicarbonate, ammonia, trimethylamine, trimethylamine, monoethanolamine, diethanolamine, triethanolamine, isopropanolamine, diisopropanolamine, triisopropanolamine, alkali metal silicates, alkaline earth metal silicates, and combinations thereof.

In some embodiments, including any of the foregoing, the additive is sodium hydroxide. In some embodiments, including any of the foregoing, the additive is potassium hydroxide. In some embodiments, including any of the foregoing, the additive is lithium hydroxide. In some embodiments, including any of the foregoing, the additive is calcium hydroxide. In some embodiments, including any of the foregoing, the additive is magnesium hydroxide. In some embodiments, including any of the foregoing, the additive is ammonium hydroxide. In some embodiments, including any of the foregoing, the additive is ammonium carbonate. In some embodiments, including any of the foregoing, the additive is ammonium chloride. In some embodiments, including any of the foregoing, the additive is calcium sulfate. In some embodiments, including any of the foregoing, the additive is calcium chloride. In some embodiments, including any of the foregoing, the additive is calcium nitrate. In some embodiments, including any of the foregoing, the additive is sodium carbonate. In some embodiments, including any of the foregoing, the additive is sodium bicarbonate. In some embodiments, including any of the foregoing, the additive is ammonia. In some embodiments, including any of the foregoing, the additive is trimethylamine. In some embodiments, including any of the foregoing, the additive is trimethylamine. In some embodiments, including any of the foregoing, the additive is monoethanolamine. In some embodiments, including any of the foregoing, the additive is diethanolamine. In some embodiments, including any of the foregoing, the additive is triethanolamine. In some embodiments, including any of the foregoing, the additive is isopropanolamine. In some embodiments, including any of the foregoing, the additive is diisopropanolamine. In some embodiments, including any of the foregoing, the additive is triisopropanolamine. In some embodiments, including any of the foregoing, the additive is alkali metal silicates. In some embodiments, including any of the foregoing, the additive is alkaline earth metal silicates.

### EXAMPLES

### Example 1—Prophetic Example

This Example shows how to quantify carbonate formation, particle sizes, and the corresponding morphological features of carbonated mineral materials

The particle size distribution (PSD) of mineral materials before and after a mechanochemical process would be measured using static light scattering (SLS) using a Beckman Coulter LS13-320 particle sizing apparatus fitted with a 750 nm light source. The solid will be dispersed into primary particles via ultrasonication in isopropanol (IPA), which would also be used as the carrier fluid. The mineralogical compositions and chemical oxide composition of the mineral materials before and after the mechanochemical process would be determined using X-ray diffraction (XRD) and X-ray fluorescence (XRF), respectively. Furthermore, the specific surface area and pore volume of untreated mineral residues would be determined using BET (Brunauer-Emmett-Teller) and BJH (Barrett-Joyner-Halenda) measurements. The BET analysis would determine the specific surface area based on the monolayer adsorption of nitrogen, and the BJH analysis would determine the pore volume based on the multilayer adsorption of nitrogen.

Thermogravimetric analysis (TGA) would be used to assess the carbonation extent and CO₂ uptake of materials before and after the mechanochemical process. Around 50 mg of powder would be extracted from finished concrete products and heated from 35° C. to 975° C. at a rate of 15° C./min in aluminum oxide crucibles under ultra-high purity N₂ gas purge at a flow rate of 20 mL/min. The carbonate content would be quantified by assessing the mass loss associated with CaCO₃ decomposition over the temperature range of 550° C. to 950° C. It should be noted that the CO₂ uptake would account for the initial quantity of carbonates that are present in the mineral materials prior to the mechanochemical process.

### Example 2—Prophetic Example

This Example shows the carbonation behavior of alkaline-rich industrial mineral materials during a mechanochemical process

A flow-through reactor would be used to expose untreated alkaline-rich mineral residues (e.g., untreated portlandite residue) and concrete composite monoliths to CO₂ gas streams at different temperatures T, relative humidities (RH), and CO₂ concentrations [CO₂]. The flow-through reactor would include at least one cylindrical reactor having an internal diameter of 100 mm and a length of 170 mm. The cylinder reactors would be sealed with threaded endcaps with 6.4 mm diameter inlets and outlets located centrally to create flow along the cylinder's axis. The reactors would be positioned horizontally in an oven with digitally control over temperature (T) (Quincy Lab, Inc.). The relative humidity (RH) and T would be monitored within each cylindrical reactor (HX71V-A, Omega; Type T thermocouples, respectively) with a data acquisition system (cDAQ-9178, National Instruments; LabVIEW 2014). Dry gas mixtures with varying CO₂ concentrations would be prepared by mixing air and CO₂ at prescribed flow rates using mass flow controllers (Alicat), providing an inlet flow rate of 2 slpm (standard liter per minute) of dry gas per reactor. The dry gas mixtures would be humidified by bubbling the gas mixtures through gas washing bottles housed in a separate oven, the temperature of which would be controlled to achieve the desired RH within the feed gas stream. The reported CO₂ concentration [CO₂] would correspond to that of the wet gas stream input into the reactors. The particulate specimens (e.g., untreated mineral sorbent residues such as portlandite) will be exposed to conditions ranging from 0.04% CO₂ (atmospheric) to 100% CO₂, 20° C. to 90° C., and 0% RH to 99% RH.

A similar set of carbonation experiments would be conducted on similar materials that would be subjected to fractionation during carbonation. Thermogravimetric analysis (TGA; STA 8000, Perkin Elmer) would be used to assess the extent of carbonation (i.e., conversion, X) experienced by the powder reactants and monoliths. Around 40 mg of carbonated material powder would be heated from 35° C. to 975° C. at 15° C./min in an aluminum oxide crucible, under a 20 mL/min ultra-high purity N₂ purge. The CO₂ content of the solid would be quantified by assessing the mass loss associated with CaCO₃ decomposition over the temperature range from 550° C. to 900° C., normalized by the mass of the initially dry powder reactant.

To qualitatively examine the effects of carbonation on compounds comprising sulfates, sulfites, and/or chlorides in mineral residues, the mineralogical compositions of mineral materials before and after CO₂ exposure would be assessed using X-ray diffraction (XRD). The XRD patterns would be collected by scanning from 5-to-70° (2θ) using a Bruker-D8 Advance diffractometer in a θ-θ configuration with Cu—Kα radiation (λ=1.54 Å) fitted with a VANTEC-1 detector. Representative powder samples would be examined to obtain averaged data over the entire sample. The diffractometer would be operated in continuous mode with an integrated step scan of 0.021° (2θ). A fixed divergence slit of 1.00° will be used during X-ray data acquisition. To minimize artifacts resulting from preferred orientation and to acquire statistically relevant data, the (powder) sample surface will be slightly textured, and a rotating sample stage would be used.

### Example 3—Prophetic Example

This Example demonstrates how to quantify the reactivity of carbonated mineral materials with different polymorphism.

The isothermal induction calorimetry, bound water, electrical resistivity, and strength activity index tests would be used to determine the reactivity of materials before and after the mechanochemical process. The effects of particle size and polymorphism of carbonate materials comprising calcite, vaterite, and aragonite, on material reactivity would be evaluated.

### Example 4—Prophetic Example

This Example demonstrates how the mechanical properties and durability of concrete composites composed of carbonated materials would be improved.

The compressive strength, water absorption, electrical resistivity of concrete composites that are composed of carbonated materials comprising calcium carbonates with different particle sizes and polymorphic forms would be measured as a function of time for up to 28 days. To provide a point of reference, similar concrete mixtures incorporating untreated mineral materials, Portland limestone cement, and/or naturally occurring limestone at similar particle sizes would be prepared, and their corresponding compressive strengths would be measured.

### Example 5—Hydration Kinetics of Alkaline-Rich Mineral Materials—Empirical Example

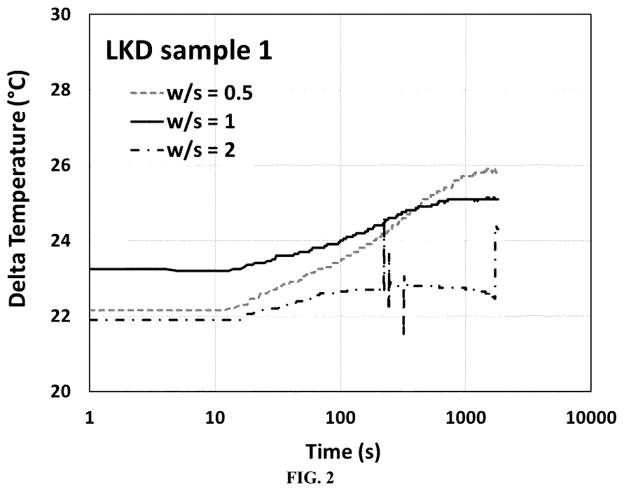

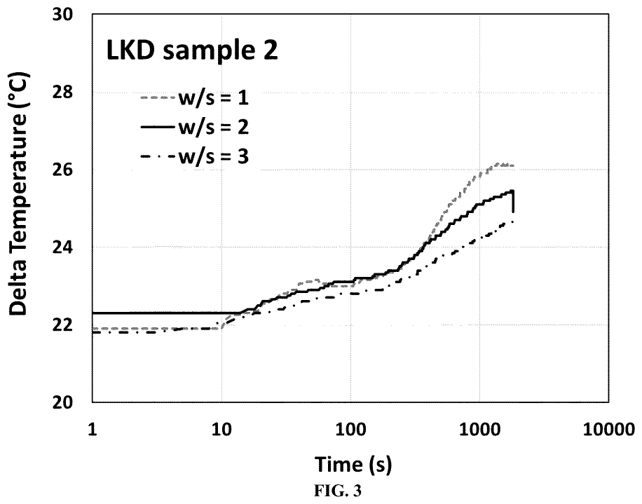

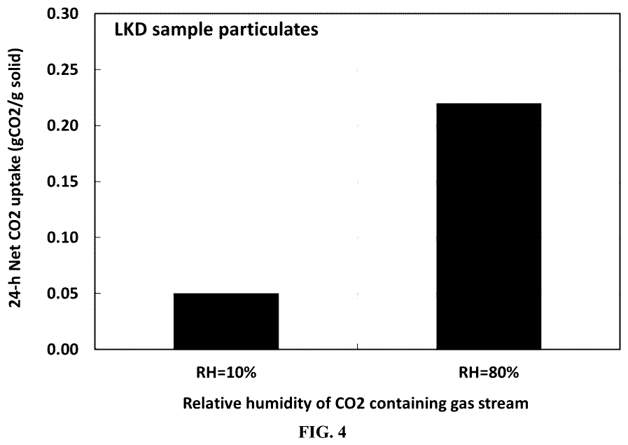

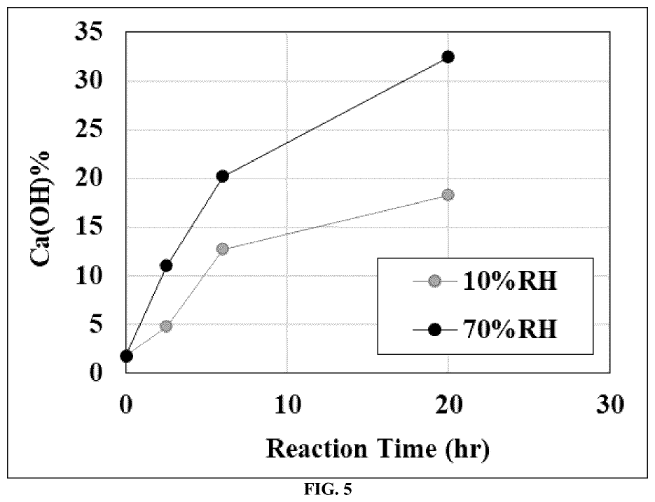

This Example showed the effects of water content and processing conditions, such as temperature and relative humidity, on the reactivity and hydration kinetics of alkaline-rich minerals. In this example, lime kiln dust was used as an alkaline-rich mineral. Two different LKDs with different free lime (CaO) contents were used (Table 1). In this example, LKD materials were used as-is without any pre-treatment or pre-carbonation. This example showed the relationship between the water content required for full hydration and the corresponding heat release of LKD as a function of free CaO content. The reactivity of samples was measured based on heat release as a function of time using the water extinction test following the European standard procedure (NF EN 549-2, 2002). Specifically, a mass of 150 g of lime is introduced into 600 g of water in an adiabatic flask and agitated by a magnetic stirrer. A thermometer was placed in the suspension to measure the temperature of the suspension. The temperature increased due to the heat released during the hydration of CaO and then reaches a plateau to a final value, which is recorded as the maximum temperature rise. Thermogravimetric analysis (TGA; STA 6000, Perkin Elmer) was used to assess the extent of Ca(OH)₂ before and after full hydration to estimate the extent of conversion of CaO to Ca(OH)₂ following the hydration reaction. Around 40 mg of carbonated material powder was heated from 35° C. to 975° C. at 15° C./min in an aluminum oxide crucible and under a 20 mL/min ultra-high purity N₂ purge. The Ca(OH)₂ content was quantified by assessing the mass loss due to dihydroxylation from the hydrated powder over the temperature range from 300° C. to 500° C. The results indicated that the water content required to achieve full hydration and their corresponding heat release is related to the free lime content of alkaline-rich materials (See FIGS. 2 and 3; and Tables 2 and 3). This example indicates that the time required to achieve full hydration in LKD samples varies with water content. This analysis can help inform the water requirement when LKD is used as a reactant in concrete mixtures. FIGS. 4-5, for example, provide example relative humidity conditions. The amount of hydration can be estimated from Table 3. During LKD hydration, lime (CaO) is converted to calcium hydroxide (Ca(OH)₂).

TABLE 1
Bulk composition of two LKD samples as determined
by X-ray fluorescence (XRF) analysis (wt. %)

| Sample | CaO | MgO | Al₂O₃ | SiO₂ | SO₃ |
|---|---|---|---|---|---|
| LKD sample 1 | 59.07 | 42.2 | 0.25 | 0.48 | 0.17 |
| LKD sample 2 | 77.1 | 3.89 | 2.57 | 5.34 | 8.48 |

TABLE 2
Complete hydration time of two LKD samples that are suspended
in water as a function of time using the water extinction test
following the European standard procedure (NF EN 549-2, 2002).

| | Water/solid by | Complete hydration |
|---|---|---|
| Sample | mass ratio | time (second) |
| LKD sample 1 | 0.5 | 815 |
| | 1 | 419 |
| | 2 | 190 |
| LKD sample 2 | 1 | 1240 |
| | 2 | 1078 |
| | 3 | 784 |

TABLE 3
Conversion of lime (CaO) to calcium hydroxide
(Ca(OH)₂) of two LKD samples after complete hydration
as determined by thermogravimetric analysis (TGA)

| | Ca(OH)₂% by weight | Ca(OH)₂% by weight |
|---|---|---|
| Sample | before hydration | after hydration |
| LKD sample 1 | 6.99 | 22.19 |
| LKD sample 2 | 19.92 | 42.53 |

### Example 6—Effects of Processing Conditions on Carbonation Kinetics of Alkaline-Rich Mineral Materials During Aqueous Carbonation—Empirical Example

This Example shows the effects of water content and processing conditions, such as temperature and relative humidity, on the carbonation kinetics of alkaline-rich minerals. In this example, lime kiln dust was used as an alkaline-rich mineral. In this example, LKD material was used as received without any pre-treatment to remove passivated carbonate layer at particle surfaces.

A flow-through reactor, as noted above, was used to expose the LKD in the form of particulates at controlled temperatures (T), relative humidities (RH), and CO₂ concentrations [CO₂]. The reactors were housed horizontally in a digitally controlled oven for temperature control. The reactor was instrumented to monitor relative humidity (RH) and temperature (T). Dry gas mixtures with varying CO₂ concentrations were prepared by mixing air and CO₂ at prescribed flow rates using mass flow controllers. To control RH, the dry gas mixtures were humidified by bubbling the gas through washing bottles housed in a separate oven, the temperature of which was controlled to achieve the desired RH within the feed gas stream. The LKD reactants were exposed to 7-100% CO₂ by volume, 20° C. to 60° C., 30% RH to 100% RH, and flow rates of 1-5 standard liters per minute (slpm).

Similar experiments were conducted using a stirring aqueous carbonation reactor system with bead mills to provide simultaneous dissolution, carbonation, and fractionation under aqueous carbonation of alkaline-rich materials. The fractionation conditions included steel balls for the media, ball to powder mill ratio of 10, RPM of 50, and the water-to-solid ratio of 0.5 to 4.

Thermogravimetric analysis (TGA; STA 6000, Perkin Elmer) was used to assess the extent of carbonation experienced by the powder reactants. Around 40 mg of carbonated material powder was heated from 35° C. to 975° C. at 15° C./min in an aluminum oxide crucible and under a 20 mL/min ultra-high purity N₂ purge. The CO₂ uptake was quantified by assessing the mass loss from the carbonated powder that is associated with CaCO₃ decomposition over the temperature range from 550° C. to 900° C., normalized by the mass of the initially dry powder placed in the TGA.

FIG. 4 shows the CO₂ uptake of LKD particulates after twenty (20) hours of exposure to 12% CO₂ by volume as a function of time at T=40-50° C. and RH=80%. The LKD samples were as shown above in Table 1. This example shows that lime-CO₂ carbonation in the dry state is very slow and limited in which carbonation proceeds via a gas-solid reaction. The gas-solid reaction is hindered by surface passivation/barrier formation on surfaces of reactants (lime). When the water in the form of liquid or vapor is present, lime (CaO) is converted into calcium hydroxide (Ca(OH)₂) (FIG. 4) and then can get carbonated rapidly following exposure to CO₂ gas stream via a dissolution-precipitation pathway which enables near complete conversion (carbonation) of lime (FIG. 5). Based on water content and carbonation exposure condition, the hydration, and carbonation of lime mineral can occur simultaneously and continuously.

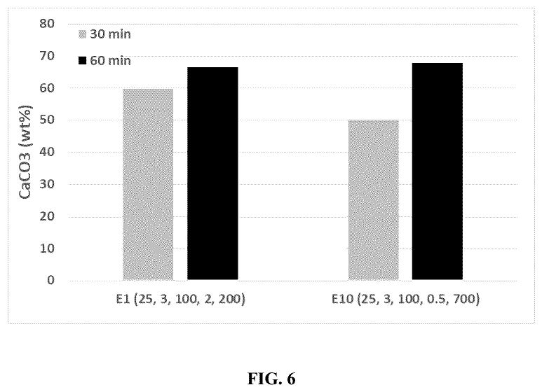

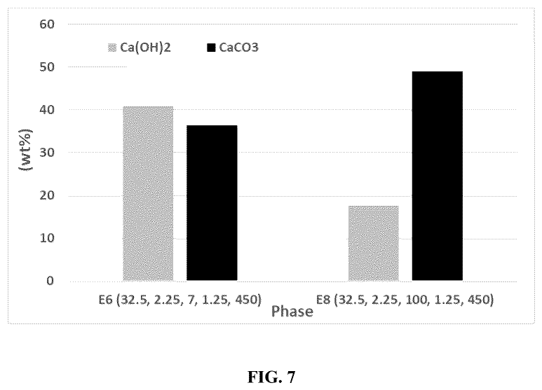

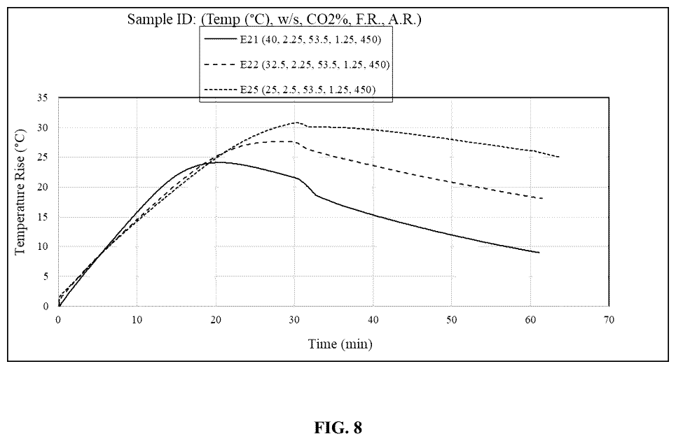

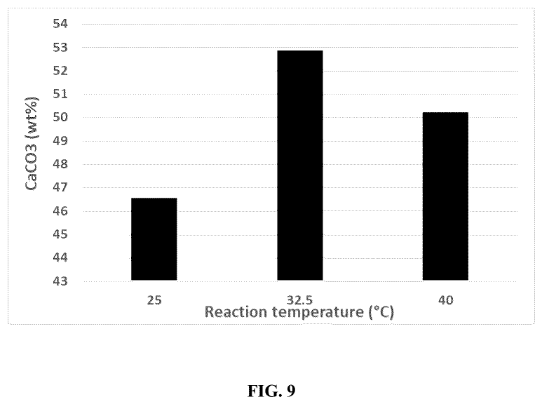

FIGS. 6-9 show the simultaneous fractionation with carbonation conversion (CaCO₃ content) of LKD under aqueous carbonation as a function of reaction time, CO₂%, flow rate, agitation speed, the water-to-solid ratio by mass, and reaction temperature. For each sample—E1 or E10—the numbers inside the parenthesis refer to, in series, the Reaction Temperature, the water-to-solid ratio, the CO₂ concentration, the flow rate, and the agitation ratio. For example, in FIG. 6, for E1 (25, 3, 100, 2, 200), the Reaction Temperature was 25° C., the water-to-solid ratio was 3, the CO₂ concentration was 100 volume percent, the flow rate was 2, and the agitation ratio was 200). The carbonation rate of LKD conversion enhances with increasing flow rate and CO₂%. There is a reaction temperature (˜32.5° C.) wherein carbonation conversion of alkaline reactants is promoted but at which additional temperature increase drops carbonation extent due to the exothermic nature of the carbonation reaction. This example demonstrates that carbonation conversion of alkaline-rich materials can be regulated by properties of CO₂-containing gas such as temperature, flow rate, and CO₂% as well as by reaction medium such as agitation/mixing speed, the reaction medium temperature and ball bead loading to control the extent of carbonation conversion of carbonatable minerals in this process in the range of about 25% to about 100%. Additionally, this example highlights that passivated carbonate layer around reactive surfaces of industrial solid wastes can be removed and depassivated to expose reactive sites and proceed with the dissolution-precipitation process.

### Example 7—Mineral Composition and Particle Size Distribution of Carbonated Alkaline-Rich Mineral Materials During Aqueous Carbonation—Empirical Example

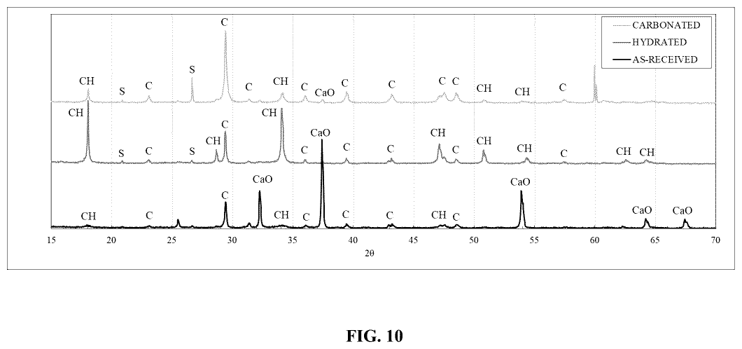

To qualitatively examine the effects of carbonation, the mineralogical compositions of alkaline-rich materials before and after carbonation with simultaneous fractioning were assessed using XRD. Alkaline-rich material before and after carbonation were extracted from aqueous carbonation, vacuum dried, and ground into fine powders, and XRD patterns were collected by scanning from 5-to-70° (2θ) using a Bruker-D8 Advance diffractometer in a θ-θ configuration with Cu—Kα radiation (λ=1.54 Å) fitted with a VANTEC-1 detector. The diffractometer was run in continuous mode with an integrated step scan of 0.021° (2θ). A fixed divergence slit of 1.00° was used during X-ray data acquisition. To minimize artifacts resulting from preferred orientation and to acquire statistically relevant data, the (powder) sample surface was slightly textured, and a rotating sample stage was used. FIG. 10 shows the XRD patterns of LKD as-received, after full hydration and after carbonation. As can be seen from the phase peak, the CaO of LKD is transformed to Ca(OH)₂ following hydration and sequentially converted to CaCO₃ following carbonation with simultaneous fractioning under an aqueous carbonation reaction medium.

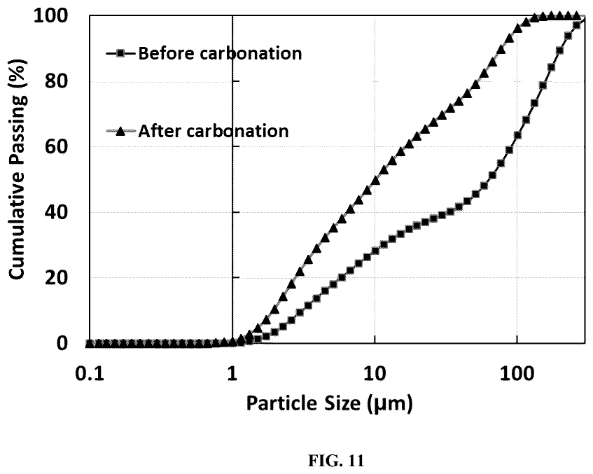

The particle size distribution (PSD) of the alkaline-rich materials before and after carbonation with simultaneous fractioning was assessed using static light scattering (SLS) using a Beckman Coulter LS13-320 particle sizing apparatus fitted with a 750 nm light source. The powders were dispersed into primary particles via ultrasonication in isopropanol (IPA), which was used as the carrier fluid in the SLS measurements. FIG. 11 shows the PSD of LKD as-received and precipitated calcium carbonates following carbonation under an aqueous carbonation reaction. As can be seen, the D₅₀ (50% passing diameter) of precipitated calcium carbonates is around 80% smaller than LKD before carbonation and fractionation using the conditions above.

### Example 8—Mechanical Properties and Hydration Reactivity of Concrete Composed of Carbonated Alkaline-Rich Minerals as Cement Replacement

This Example demonstrated the mechanical properties and hydration reactivity of concrete composites composed of carbonated materials. In this example, lime kiln dust was used as an alkaline-rich mineral. In this example, the replacement rate of cement by uncarbonated or carbonated alkaline-rich mineral was set between 10-20 mass %. The compressive strength of concrete composites that were composed of carbonated materials comprising calcium carbonates was measured as a function of time. To provide a point of reference, similar concrete mixtures incorporating portland cement and portland cement with uncarbonated alkaline-rich materials were prepared and tested for compressive strength. The influence of cement replacement with carbonated materials on the rate of reactions was tracked using isothermal conduction calorimetry. A TamAir isothermal calorimeter (TA Instruments) was used to determine the heat evolved during hydration at a constant temperature condition of 25° C. The thermal power and energy measured were then used to assess the influence of calcium carbonate precipitates on the reaction kinetics and cumulative heat release of the cementitious pastes.

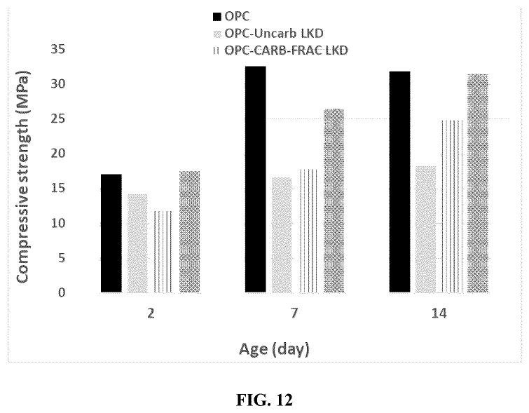

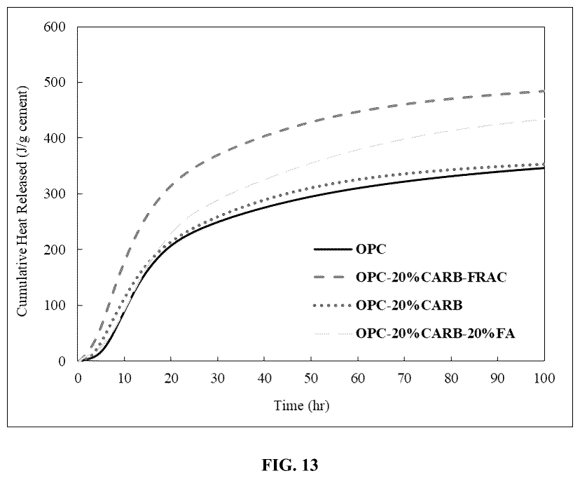

FIGS. 12 and 13 show the effects of carbonated materials on the compressive strength and hydration kinetics of cementitious paste mixtures. The concrete mixture comprising carbonated LKD showed higher strength than uncarbonated LKD mixtures. Additionally, when carbonated LKD in combination with aluminosilicate materials such as fly ash was used at 30 mass % replacement for cement, the concrete mixtures indicated nearly comparative strength as reference concrete mixture made with portland cement. This shows a chemical synergy between aluminosilicate and carbonated minerals in a concrete mixture. The results indicate precipitated calcium carbonate addition is beneficial for concrete mixtures comprising aluminosilicate to improve compressive strength. When carbonate ions are present, for example, when provisioned by the dissolution of the CO₂ gas stream during carbonation curing as in this EXAMPLE 8, aluminosilicate materials react with carbonate species to form the CO₃-AFm (i.e., carbonate-AFm) phases. The extent of CO₂ conversion of carbonatable minerals in this process can be controlled to supplement the chemical reaction among carbonated minerals, uncarbonated alkaline-rich minerals, and other constituents in a binder system comprising cement and fly ash in concrete mixtures.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure. It should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto.

1. A mechanochemical process for making calcium carbonate, comprising:
providing alkaline-rich mineral materials that are at least partially carbonated;
simultaneously fractioning the alkaline-rich mineral materials, while contacting the alkaline-rich mineral materials with a CO₂-containing gas;
wherein the contacting occurs at ambient pressure and temperatures ranging from 20° C. to 80° C.;
thereby making calcium carbonate.

2. The process of claim 1, wherein the process includes providing alkaline-rich mineral materials in a solution or slurry, and simultaneously fractioning the alkaline-rich mineral materials in the solution or slurry, while contacting the alkaline-rich mineral materials with a CO₂-containing gas; and wherein the process further comprises filtering the calcium carbonate from the solution.

3. The process of claim 2, wherein the solution comprises hydroxide ions, alkaline metal ions, or a combination thereof.

4. (canceled)

5. (canceled)

6. The process of claim 1, further comprising using the calcium carbonate made by the process as a reactive filler or supplementary cementitious material to make concrete.

7. The process of claim 6, comprising using the calcium carbonate made by the process in a slurry, as a moist powder, or as a dry powder.

8. (canceled)

9. (canceled)

10. The process of claim 1, further comprising conditioning the CO₂-containing gas to achieve an extent of carbonation conversion and carbonation rate of alkaline-rich mineral minerals of about 25% to about 100%.

11. The process of claim 1, further comprising controlling the carbonation reaction rate of the alkaline-rich minerals by adjusting flow rate, temperature, CO₂ concentration, and the time during which the CO₂-containing gas contacts the alkaline-rich minerals.

12.-16. (canceled)

17. The process of claim 1, wherein the carbonation products are mainly calcium carbonates comprising vaterite, aragonite, calcite, and alumina-silica gel, or a combination thereof.

18. The process of claim 1, wherein the process occurs in a carbonation chamber.

19. The process of claim 1, wherein the process occurs in a carbonation reactor comprising a flow through reactor, aqueous reactor, or stirring reactor, and wherein the reaction medium is selected from dry, semi-dry and aqueous reaction medium.

20. (canceled)

21. (canceled)

22. The process of claim 1, wherein the CO₂-containing gas is a flue gas effluent from an industrial CO₂-containing gas stream, dilute flue gas stream, a concentrated CO₂ gas stream, a commercially available CO₂ source, liquefied CO₂, atmospherically-derived CO₂ (direct air capture), or biomass-derived CO₂.

23. The process of claim 22, wherein the atmospherically-derived CO₂ is direct air capture CO₂.

24. The process of claim 1, wherein fractioning the alkaline-rich mineral materials increases the surface area of the alkaline-rich mineral materials.

25. The process of claim 1, wherein prior to fractioning the alkaline-rich mineral materials, the alkaline-rich mineral materials are fully carbonated at their particle surfaces.

26.-29. (canceled)

30. The process of claim 1, wherein the process occurs in a flow-through reactor.

31.-35. (canceled)

36. The process of claim 1, wherein the alkaline-rich mineral materials are alkaline-rich mineral residues, and wherein the alkaline-rich mineral residues are generated from industrial processes such as cement kiln dust, lime kiln dust, coal combustion residues, fly ash, slag off-spec limes, or carbide lime.

37. (canceled)

38. (canceled)

39. The process of claim 1, wherein the alkaline-rich mineral material is a portlandite residue.

40. (canceled)

41. The process of claim 1, wherein the temperature of the CO₂-containing gas ranges from 20° C. to about 60° C.

42.-49. (canceled)

50. The process of claim 1, wherein the CO₂ concentration of the CO₂-containing gas ranges from 5% to about 100% by volume.

51. The process of claim 1, wherein the time for contacting the alkaline-rich mineral materials with a CO₂-containing gas ranges from 5 minutes to about 48 hours.

52.-61. (canceled)
